(19) United States
(12) Patent Application Publication
(10) Pub. No.: US 2015/0030281 A1
(43) Pub. Date: Jan. 29, 2015

(54) METHODS AND APPARATUSES FOR PREVENTING AN OPTICS SYSTEM OF AN OPTICAL COMMUNICATIONS MODULE FROM BEING DAMAGED OR MOVED OUT OF ALIGNMENT BY EXTERNAL FORCES

(71) Applicant: Avago Technologies General IP (Singapore) Pte, Ltd., Singapore (SG)

(72) Inventors: Seng-Kum Chan, Santa Clara, CA (US); Bing Shao, Sunnyvale, CA (US); Hui Xu, Santa Clara, CA (US); Pengyue Wen, San Jose, CA (US); David J.K. Meadowcroft, San Jose, CA (US)

(73) Assignee: Avago Technologies General IP (Singapore) Pte, Ltd., Singapore (SG)

(21) Appl. No.: 13/951,075

(22) Filed: Jul. 25, 2013

(51) Int. Cl. G02B 6/42

(52) U.S. Cl. CPC G02B 6/4201
USPC 385/14

(57) ABSTRACT

Protection features are incorporated into an optical communications module to ensure that the optics system of the module will not be damaged or moved out of alignment by external forces exerted on a mating surface of the module when a connector module is mated with the optical communications module. One protection feature is a strike plate that is disposed on the mating surface of the module that redistributes forces exerted on the mating surface. Another protection feature is an optically-transmissive window formed in the mating surface and comprising an optically-transmissive element having anti-reflection (AR) coatings disposed on its upper and lower surfaces. The optics system is positioned beneath the mating surface so that forces that are exerted on the mating surface are not transferred to the optics system. Another protection feature is a design of the module that mechanically decouples the optics system from the mating surface.

### TECHNICAL FIELD OF THE INVENTION

The invention relates to optical communications modules. More particularly, the invention relates to methods and apparatuses for preventing an optics system of an optical communications module from being damaged or moved out of alignment by external forces.

### BACKGROUND OF THE INVENTION

An optical communications module is a module having one or more transmit (Tx) channels, one or more receive (Rx) channels, or one or more Tx channels and one or more Rx channels. In an optical communications module that has at least one Tx channel, the Tx portion comprises components for transmitting data in the form of modulated optical signals over multiple optical waveguides, which are typically optical fibers. The Tx portion includes a laser driver integrated circuit (IC), a plurality of laser diodes and a controller IC, which are typically mounted on a module printed circuit board (PCB). The laser driver circuit outputs electrical signals to the laser diodes to modulate them. When the laser diodes are modulated, they output optical signals that have power levels corresponding to logic 1s and logic 0s. An optics system of the module focuses the optical signals produced by the laser diodes into the ends of respective transmit optical fibers of an optical fiber cable, such as an optical fiber ribbon cable.

In an optical communications module that has at least one Rx channel, the Rx portion includes a plurality of receive photodiodes mounted on the PCB that receive incoming optical signals output from the ends of respective receive optical fibers held in the connector. The optics system of the optical communications module focuses the light that is output from the ends of the receive optical fibers onto the respective receive photodiodes. The receive photodiodes convert the incoming optical signals into electrical analog signals. An electrical detection circuit, such as a transimpedance amplifier (TIA), receives the electrical signals produced by the receive photodiodes and outputs corresponding amplified electrical signals, which are processed in the Rx portion to recover the data.

The optics system is typically disposed in a surface of the module that is comes into direct contact with a connector module that holds the ends of the optical fibers. The connector module and the optical communications module typically have mating features on them that mate with each other to lock the modules together and to bring the ends of the optical fibers into alignment with respective optical elements of the optics system. One of the problems associated with mating the connector module with the optical communications module is that the connector module exerts forces on the optical communications module that can damage the optics system.

FIGS. 1A-1D demonstrate the manner in which a known connector module 2 mates with a known optical communications module 3 and the forces that are exerted by the connector module 2 on the optical communications module 3 during the mating process. FIG. 1A is a side plan view of the connector module 2 positioned above the optical communications module 3 at the beginning of the mating process. FIG. 1B is a side plan view of the connector module 2 mating with the optical communications module 3. FIG. 1C is a side plan view of the connector module 2 positioned above the optical communications module 3 and misaligned with the optical communications module 3 at the beginning of the mating process. FIG. 1D is a side plan view of the connector module 2 coming into contact with the optical communications module 3 during the mating process due to misalignment of the modules 2 and 3.

The connector module 2 has pins 4 and 5 disposed on a lower surface thereof that are shaped and sized to mate with holes 6 and 7 formed in the optical communications module 3. The holes 6 and 7 are generally complementary in shape to the shapes of the pins 4 and 5. The connector module 2 has ends of one or more optical fiber cables 8 secured thereto. An optics system (not shown) of the connector module 2 bends the optical pathways of light passing out of the optical fiber cables 8 by an angle of 90° and bends the optical pathways of light received from the optical communications module 3 by an angle of 90°. The optical communications module 3 has an optics system 11 disposed therein. The optics system 11 is typically embedded in, an upper, mating surface 12 of the optical communications module 3. One of the reasons for embedding the optics system 11 in the mating surface 12 is to help seal the housing 13 to provide isolation of the electronic and optoelectronic components of the module from environmental dusts, water vapor, mixed flow gases (MFGs), and contaminants.

When the connector module 2 is being mated with the optical communications module 3, if the pins 4 and 5 mate with the holes 6 and 7, respectively, on the first attempt without coming into contact with the mating surface 12 of the optical communications module 3, then very little if any mechanical stress is exerted on the housing 13 of the optical communications module 3. FIGS. 1A and 1B depict the scenario in which the pins 4 and 5 mate with the holes 6 and 7, respectively, on the first attempt without coming into contact with the mating surface 12 of the optical communications module 3.

If, however, one or both of the pins 4 and 5 come into contact with the mating surface 12 of the optical communications module 3 during the mating process, as shown in FIG. 1D, a corresponding force is exerted on the housing 13 of module 3 that is transferred to the optics system 11. The lines 14 in FIG. 1D represent the force being transferred through the housing 13 to the optics system 11. As indicated by the locations of the lines 14, the force is concentrated around the location of the optics system 11 due to the fact that the pin 4 abuts with the mating surface 12 at a location that is above the location of the optics system 11. The force that is transferred into the portion of the housing 13 that surrounds the optics system 11 can distort the housing 13 and cause the optics system 11 to crack or break. If the optics system 11 cracks or breaks, the module 3 is generally rendered useless. Moreover, even if the forces applied to the optics system 11 do not crack or break the optics system 11, such forces can move the optics system 11 out of alignment, which can result in performance problems and optical losses.

Known solutions to this problem have focused on equipping the connector module 2 with a guide (not shown) that limits the range of movement of the pins 4 and 5 by acting as a funnel that helps guide the connector module 2 into engagement with the optical communications module 3. The guide essentially prevents the pins 4 and 5 from “jabbing” the mating surface 12 of the optical communications module 3. One of the disadvantages of such an approach is that it requires attaching a relatively large funnel to the connector module, which decreases the density with which adjacent modules can be mounted and provides less room for other essential components, such as heat sink structures.

Accordingly, a need exists for an optical communications module having a design that prevents the optics system of the module from being damaged or moved out of alignment by external forces, such as those that may be exerted on the optical communications module during the process of mechanically coupling the connector module to the optical communications module.

### SUMMARY OF THE INVENTION

The invention is directed to an optical communications module having one or more protection features for ensuring that the optics system of the module will not be damaged or moved out of alignment by external forces that may be exerted on the module.

In accordance with one embodiment, the optical communications module comprises a circuit board, one or more electronic and optoelectronic components mounted on an upper surface of the circuit board, a module housing mechanically coupled to the circuit board, an optics system disposed in the module housing, and a strike plate disposed on at least a portion of a mating surface of the module housing. The strike plate has at least a first opening extending through the strike plate for allowing light to be optically coupled between a connector module and the optics system when the optical communications module is engaged in a mating arrangement with a connector module. The strike plate is adapted to redistribute a force exerted on the strike plate by the connector module such that the redistributed force is generally equally distributed over the portion of the mating surface on which the strike plate is disposed.

In accordance with another embodiment, the optical communications module comprises a circuit board, one or more electronic and optoelectronic components mounted on an upper surface of the circuit board, a module housing mechanically coupled to the circuit board, and an optics system disposed in the module housing. The mating surface of the module housing has an optically-transmissive window formed therein. A frame is disposed in the module housing beneath the optically-transmissive window and above the upper surface of the circuit board. The frame is mechanically decoupled from the mating surface. The optics system is mounted on the frame beneath the optically-transmissive window. If external forces are exerted on the mating surface of the module housing, the mechanical decoupling of the frame from the mating surface helps prevent such external forces from being transferred to the optics system.

In accordance with another embodiment, the optical communications module comprises a circuit board, one or more electronic and optoelectronic components mounted on an upper surface of the circuit board, a module housing mechanically coupled to the circuit board, and an optics system disposed in the module housing. The mating surface of the module housing has an optically-transmissive window formed therein. An optically-transmissive element is disposed in the optically-transmissive window. The optically-transmissive element has upper and lower surfaces that are parallel to one another and parallel to the mating surface. The upper and lower surfaces of the optically-transmissive element have first and second anti-reflection (AR) coatings, respectively, disposed thereon for passing light of an operating wavelength of the optical communications module. The optics system is disposed in the module housing beneath the optically-transmissive element and above the upper surface of the circuit board.

The invention is also directed to methods for protecting an optics system of an optical communications module from being damaged by external forces that are applied to a mating surface of the module. In accordance with one embodiment, the method comprises disposing a strike plate on at least a portion of a mating surface of a housing of an optical communications module. The strike plate has at least a first opening extending through the strike plate for allowing light to be optically coupled between a connector module and the optical communications module when the optical communications module is matingly engaged with the connector module. The strike plate is adapted to redistribute a force exerted on the strike plate by the connector module such that the redistributed force is generally equally distributed over the portion of the mating surface on which the strike plate is disposed.

In accordance with another embodiment, the method comprises disposing an optics system on a frame that is disposed in the housing of the optical communications module beneath an optically-transmissive window formed in a mating surface of the housing. The frame is mechanically decoupled from the mating surface such that if external forces are exerted on the mating surface of the housing, the mechanical decoupling of the frame from the mating surface helps prevent such external forces from being transferred to the optics system.

In accordance with another embodiment, the method comprises providing a mating surface of a housing of an optical communications module with an optically-transmissive window having an optically-transmissive element disposed therein, and disposing an optics system in the housing beneath the optically-transmissive element and above at least one optoelectronic component mounted an upper surface of a circuit board of the module. The optically-transmissive element has upper and lower surfaces that are parallel to one another and parallel to the mating surface. The upper and lower surfaces of the optically-transmissive element have first and second AR coatings, respectively, disposed thereon for passing light of an operating wavelength of the optical communications module. The optics system is mechanically decoupled from the mating surface to help prevent forces that are exerted on the mating surface from being transferred to the optics system.

These and other features and advantages of the invention will become apparent from the following description, drawings and claims.

### BRIEF DESCRIPTION OF THE DRAWINGS

FIGS. 1A-1D demonstrate the manner in which a known connector module mates with a known optical communications module and the forces that are exerted by the connector module on the optical communications module during the mating process.

FIG. 2 illustrates a side plan view of an optical communications module in accordance with an illustrative embodiment having a strike plate disposed on a mating surface of the module.

FIG. 3 illustrates a top plan view of an optical communications module in accordance with another illustrative embodiment having a strike plate disposed on a mating surface of the module.

FIG. 4 illustrates a perspective view of the strike plate shown in FIG. 3.

FIG. 5 illustrates a top perspective view of the optical communications module shown in FIG. 3 about to be mated with a connector module.

FIG. 6 illustrates a top perspective view of an optical communications module in accordance with another illustrative embodiment having a strike plate disposed on a mating surface of the module.

FIG. 7 illustrates a perspective view of the strike plate shown in FIG. 6.

FIG. 8 illustrates a top perspective view of an optical communications module in accordance with another illustrative embodiment having a strike plate disposed on a mating surface of the module.

FIG. 9A is a cross-sectional perspective view of the optical communications module shown in FIG. 8 taken along the A-A′ line shown in FIG. 8.

FIG. 9B illustrates an enlarged view of the encircled portion 370 of the optical communications module shown in FIG. 9A.

FIGS. 10A and 10B illustrate top and bottom perspective views, respectively, of a frame shown in FIGS. 9A and 9B for holding the optics system shown in FIGS. 9A and 9B and mechanically decoupling the optics system from the housing of the optical communications module.

FIG. 11 illustrates a top perspective view of the frame shown in FIGS. 10A and 10B with the optics system shown in FIGS. 9A and 9B secured thereto.

FIG. 12 illustrates a top perspective view of the optical communications module shown in FIGS. 8-9B with the housing removed to reveal the components of the module that are housed within the housing, including the frame and the optics system shown in FIG. 11.

### DETAILED DESCRIPTION OF AN ILLUSTRATIVE EMBODIMENT

In accordance with the invention, one or more protection features are incorporated into the optical communications module to ensure that the optics system of the module will not be damaged or moved out of alignment by external forces that may be exerted on the module. Any of these protection features may be used alone or in combination to prevent the optics system of the module from being damaged or moved out of alignment by external forces.

One of the protection features is a strike plate that is disposed on the mating surface of the module. The strike plate redistributes the mechanical load associated with mating pins of the connector module coming into contact with the strike plate during the process of mating the connector module with the optical communications module. Redistributing the mechanical load reduces the magnitude of forces that are transferred to the optics system, which prevents the optics system from being damaged or moved out of alignment.

Another of the protection features is an optically-transmissive window formed in the mating surface of the optical communications module above the location at which the optics system is disposed. The window comprises an optically-transmissive element having anti-reflection (AR) coatings disposed on its upper and lower surfaces. The optics system of the optical communications module is disposed beneath the optically-transmissive element. By positioning the optics system beneath the mating surface rather than embedding it in the mating surface, any forces that are exerted on the mating surface by the connector module during the mating process are not exerted directly on the optics system. In this way, the window helps prevent the optics system from being damaged or moved out of alignment by external forces that are exerted on the optical communications module by the connector module during the mating process. The AR coatings allow light to pass through the optically-transmissive element of the transparent window without being reflected at these surfaces so that Fresnel losses are minimized.

Another of the protection features is provided by the design of the optical communications module. The design is such that the optics system is mechanically decoupled from the housing of the optical communications module. More specifically, in accordance with an illustrative embodiment, the optics system is disposed on a frame that is beneath the mating surface and that is mechanically decoupled from the housing and from the mating surface, which is part of the housing. Mechanically decoupling the optics system from the mating surface prevents forces that may be exerted on the mating surface by the connector module during the mating process from being transferred to the optics system. In this way, the design of the optical communications module prevents the optics system from being damaged or moved out of alignment by such forces.

One or more of the above-described protection features are incorporated into the optical communications module, as will now be described with reference to illustrative embodiments, in which like reference numerals represent like features, components or elements.

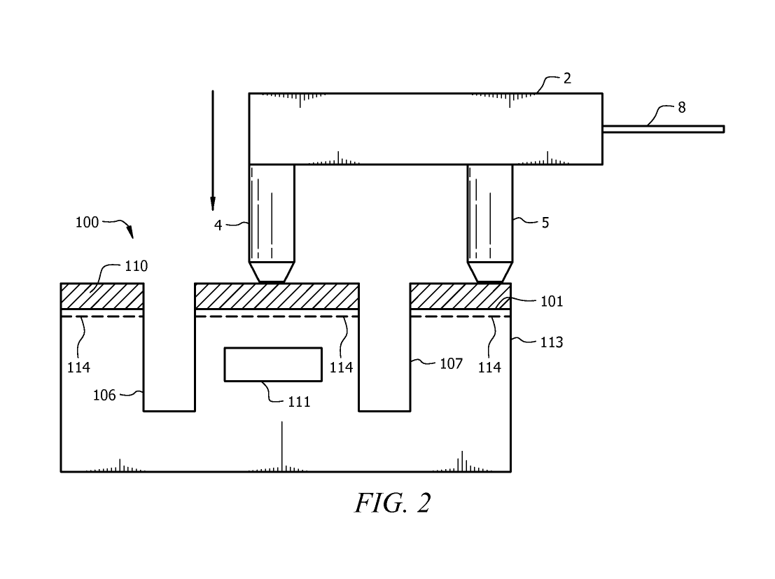

FIG. 2 illustrates a side plan view of an optical communications module 100 in accordance with an illustrative embodiment having a strike plate 110 disposed on a mating surface 101 of the module 100. The strike plate 110 evenly distributes a mechanical load associated with abutment of the pins 4 and/or 5 of the connector module 2 with the strike plate 110 during the process of mating the connector module 2 with the optical communications module 100. The pins 4 and 5 of the connector module 2 are shaped and sized to mate with holes 106 and 107, respectively, formed in the optical communications module 100. An optics system 111 of the optical communications module 100 is disposed inside of a housing 113 of the module 100 beneath the mating surface 101 of the module 100.

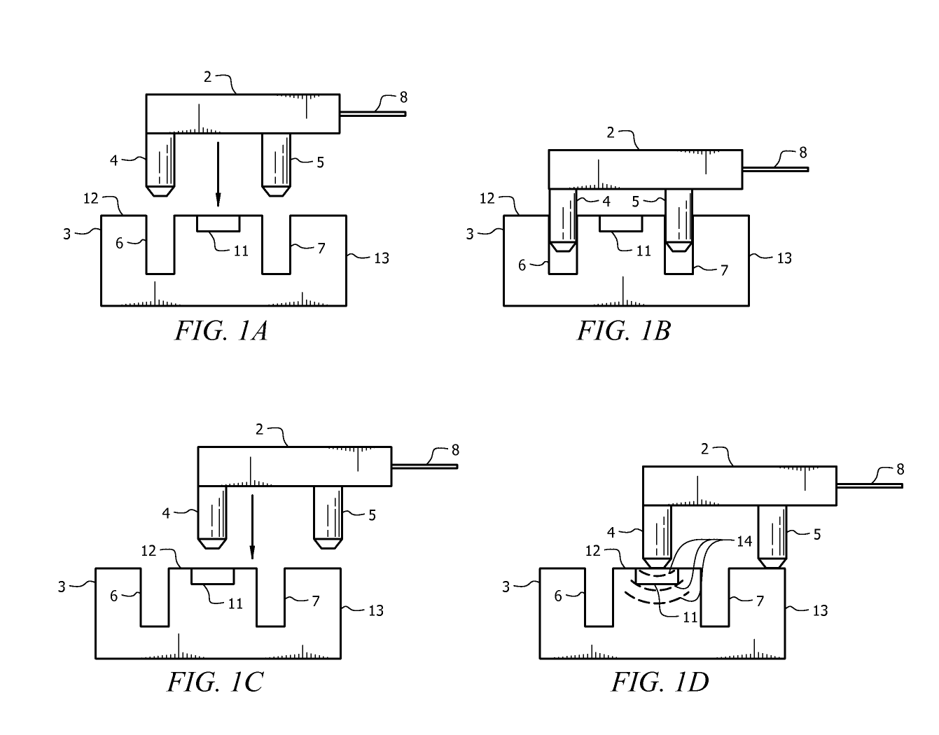

When the connector module 2 is being mated with the optical communications module 100, if one or both of the pins 4 and 5 come into contact with the strike plate 110 of the optical communications module 100, as depicted in FIG. 2, the strike plate 110 will cause the corresponding force to be generally evenly distributed into the housing 113. The lines 114 represent this force being generally evenly distributed into the housing 113. A comparison of the lines 114 with the lines 14 shown in FIG. 1D demonstrates the difference between the manner in which the forces are distributed in the modules 100 and 3, respectively. In the module 3, the force represented by lines 14 is concentrated in the portion of the housing 13 that is directly underneath the pin 4, which is where the optics system 11 is located. In contrast, in the module 100, the force represented by lines 114 is evenly distributed into the housing 113, which means that a smaller portion of the total force is transferred into the optics system 111. The reduction in the portion of the total force that is transferred into the optics system 111 reduces the likelihood that the optics system 111 will be damaged or moved out of its aligned position by the force.

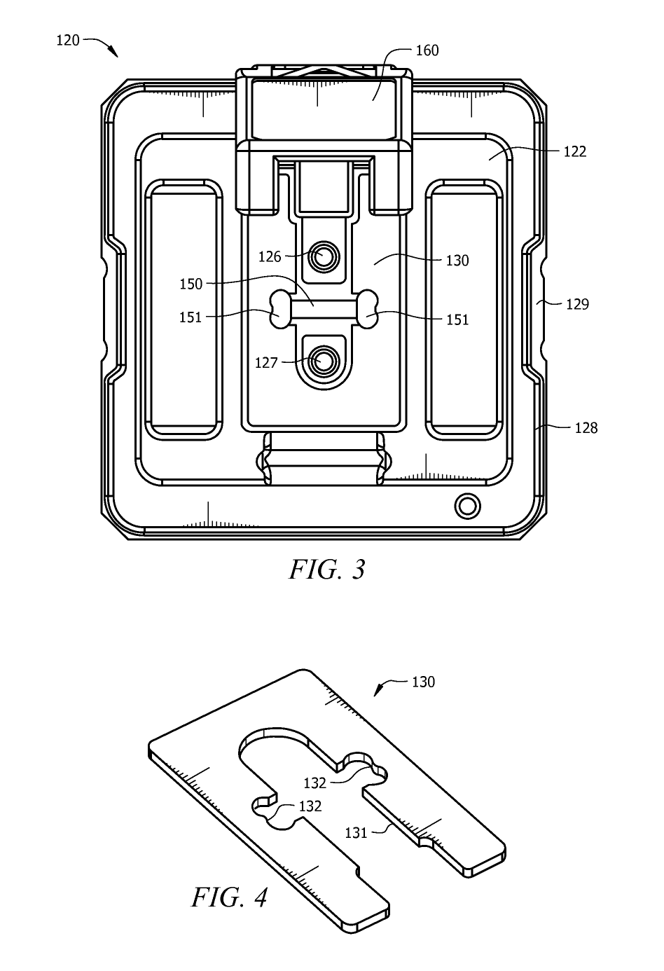

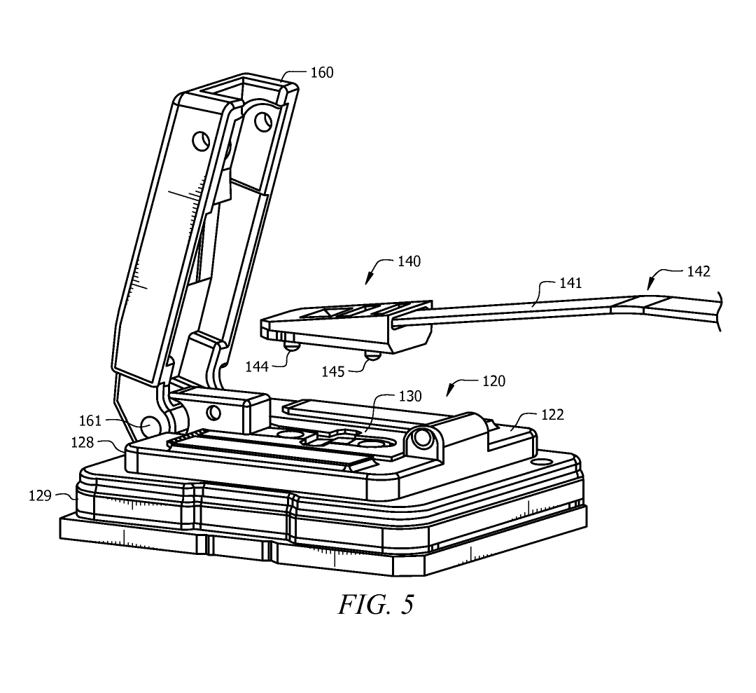

FIG. 3 illustrates a top plan view of an optical communications module 120 in accordance with another illustrative embodiment. The module 120 has a strike plate 130 disposed on a mating surface 122 of the module 120. The mating surface 122 is an upper surface of a cover 128 that forms part of a housing 129 of the module 120. The cover 128 and the housing 129 encase components (not shown) of the module 120 and generally protect them from external forces and contaminants. FIG. 4 illustrates a perspective view of the strike plate 130 shown in FIG. 3. FIG. 5 illustrates a perspective view of the optical communications module 120 shown in FIG. 3 being mated with a connector module 140 that is connected to ends (not shown) of a plurality of optical fibers 141 of an optical fiber cable 142.

The strike plate 130 can have various shapes and sizes and can be made of various materials. Typically, the strike plate 130 is made of a hard material such as, for example, sheet metal, aluminum, or hard plastic. One reason for making the strike plate 130 out of metal is that metal can be easily and inexpensively shaped by a stamping process. Another reason for making the strike plate 130 out of metal is that metal parts can be made to have a rigidity that allows them to spread a mechanical load applied to a particular point over a wide surface area. One reason for making the strike plate 130 out of plastic is that plastic products having the desired qualities of rigidity for spreading out the mechanical load can be easily and inexpensively made. However, other materials and processes may be used to make the strike plate 130.

The strike plate 130 has a cutaway region 131 (FIG. 4) formed therein that provides access to mating holes 126 and 127 (FIG. 3) formed in the module 120. The mating holes 126 and 127 (FIG. 3) are shaped and sized to mate with mating pins 144 and 145 (FIG. 5), respectively, disposed on a lower surface of the connector module 140 (FIG. 5). The cutaway region 131 (FIG. 4) has a portion 132 that provides an opening through which light can be coupled between the optical communications module 120 and the connector module 140 through a window 150 (FIG. 3) of the optical communications module 120.

The strike plate 130 protects the optics system (not shown) in the manner described above with reference to FIG. 2. With reference to FIG. 5, if the pins 144 and/or 145 come into contact with the strike plate 130 during the process of mating the connector module 140 with the optical communications module 120, the force that is exerted on the strike plate 130 by the connector module 140 will be evenly distributed by the strike plate 130 into the housing 129 of the module 120. In this way, the strike plate 130 prevents forces exerted on the optical communications module 120 from being localized around the optics system (not shown), which is disposed inside of the housing 129 beneath the mating surface 122 and in alignment with the window 150.

In accordance with this illustrative embodiment, the optical communications module 120 includes a lid 160 (FIGS. 3 and 5) that is rotationally coupled to the module 120 by fastening devices 161 (FIG. 5). The lid 160 can be placed in the opened position shown in FIGS. 3 and 5 to allow the connector module 140 to be mated with the optical communications module 120. When the connector module 140 is not mated with the optical communications module 120, the lid 160 can be placed in a closed position to further protect the mating surface 122 and the window 150 from external forces, dust, gases, and other environmental factors. In accordance with this illustrative embodiment, the cutout region 131 (FIG. 4) of the strike plate 130 has an ear-shaped portion 132 that provides access to additional surface areas 151 on the window 150 (FIG. 3) for wiping dirt or debris away from the window 150 to prevent dirt or debris from interfering with the optical pathways.

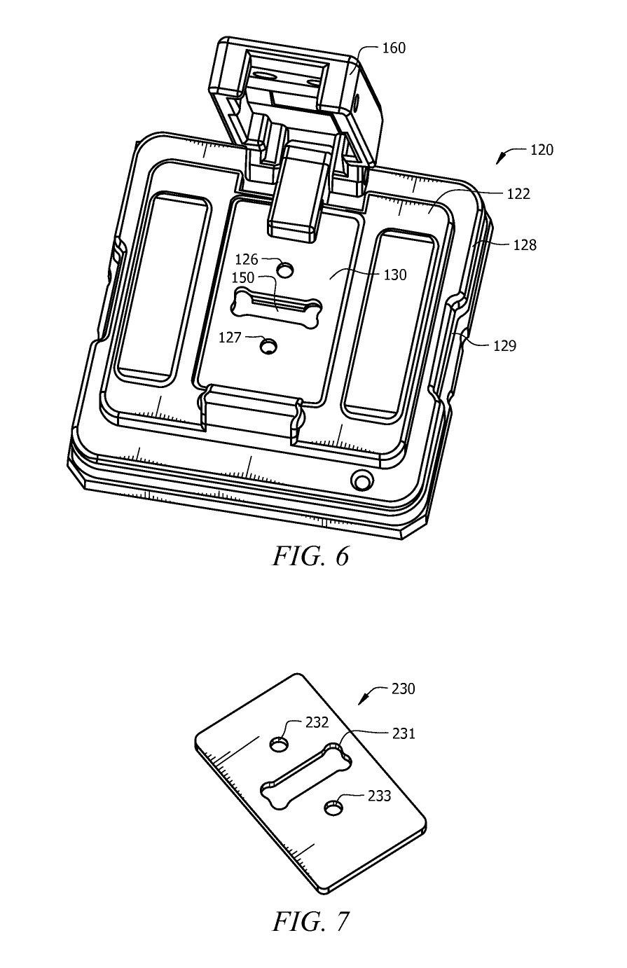

FIG. 6 illustrates a top perspective view of the optical communications module 120 shown in FIG. 3 with a strike plate 230 disposed thereon that is different from strike plate 130. FIG. 7 illustrates a perspective view of the strike plate 230 shown in FIG. 6. Again, the strike plate 230 is typically, but not necessarily, made of metal such as sheet metal or aluminum, for example. The strike plate 230 has cutaway regions 231, 232 and 233 formed therein that provide access to the window 150, the mating hole 126 and the mating hole 127, respectively, formed in the module 120.

The strike plate 230 protects the optics system (not shown) of the module 120 in the manner described above, but provides even slightly better protection than that provided by the strike plate 130 shown in FIG. 4. Because the cutaway region 131, 132 of the strike plate 130 is larger in area than the cutaway regions 231-233 of the strike plate 230, there is a greater chance when using the strike plate 130 that the mating pins 144 and 145 of the connector module 140 shown in FIG. 5 will come into contact with a portion of the mating surface 122 that is not covered by the strike plate 130 than there is with the strike plate 230. Because the cutaway regions 231-233 of the strike plate 230 are only at locations that are absolutely necessary to provide access to the holes 126 and 127 and the window 150, there is less of a chance that the mating surface 122 will come into direct contact with the pins 144 and/or 145 (FIG. 5).

The strike plate 230 performs the same function as the strike plate 130 of redistributing the force exerted by the pins 144 and/or 145 on the strike plate 230. If the pins 144 and/or 145 come into contact with the strike plate 230 during the process of mating the connector module 140 with the optical communications module 120, the force that is exerted on the strike plate 230 will be evenly distributed by the strike plate 230 into the housing 129 of the module 120. In this way, the strike plate 230 prevents forces exerted on the optical communications module 120 from being concentrated in the vicinity of the optics system (not shown).

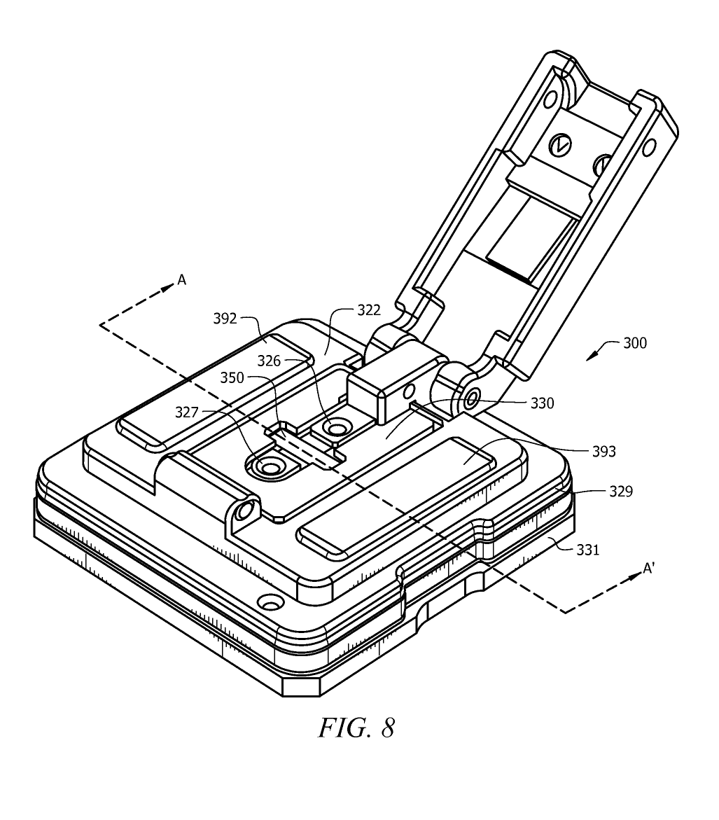

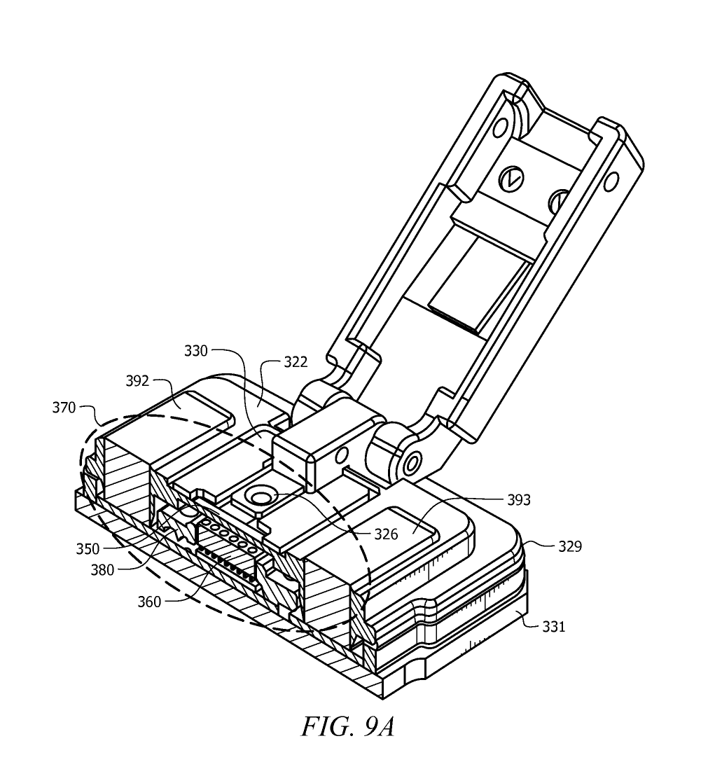

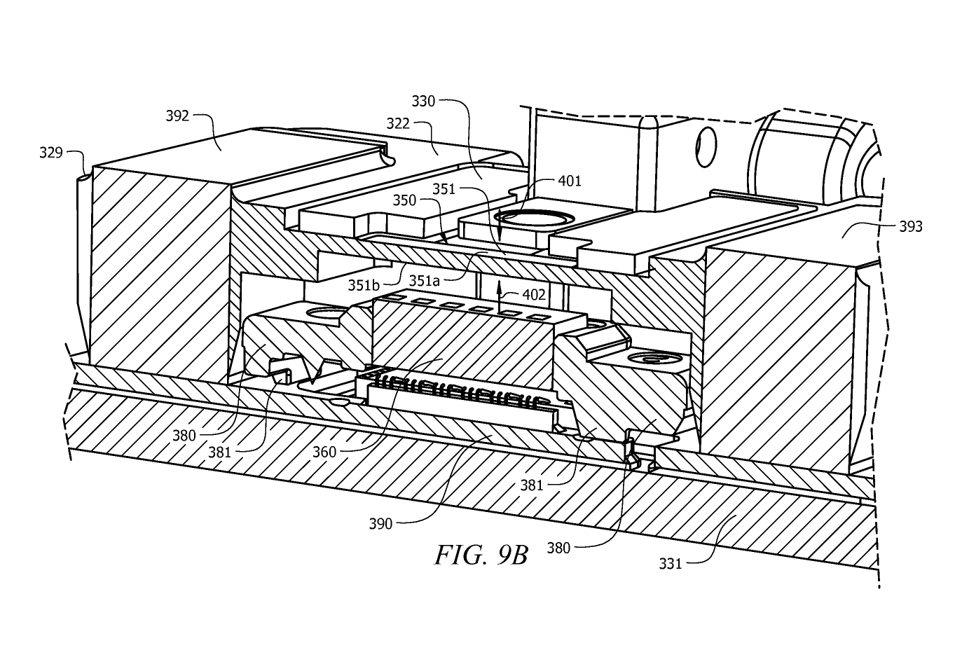

FIG. 8 illustrates a top perspective view of an optical communications module 300 in accordance with another illustrative embodiment. FIG. 9A illustrates a top perspective cross-sectional view of the optical communications module 300 shown in FIG. 8 taken along line A-A′ of FIG. 8. FIG. 9B illustrates an expanded view of the portion of the module 300 shown in FIG. 9A within the circle 370 of FIG. 9A. In accordance with this illustrative embodiment, the module 300 includes not only the strike plate protection feature, but also includes the aforementioned protection features of the optically-transmissive window and the decoupled optics system.

The strike plate 330 is identical or very similar to the strike plate 130 shown in FIG. 4. The mating holes 326 and 327 are shaped and sized to mate with mating pins 144 and 145 (FIG. 5), respectively, disposed on a lower surface of the connector module 140 (FIG. 5). The strike plate 330 provides the same protections as the strike plates 130 and 230 described above and therefore will not be described herein in further detail. In FIGS. 9A and 9B, the relative positions of the mating surface 322 of the module, the strike plate 330, the optically-transmissive window 350, and the optics system 360 can be seen. In many known optical communications module designs, the optics system is in contact with the mating surface, and is often embedded in the mating surface. In accordance with this illustrative embodiment, the optics system 360 is disposed beneath the mating surface 322 and the window 350 and is mechanically decoupled from both the module housing 329 and the mating surface 322.

More specifically, in accordance with this illustrative embodiment, the optics system 360 is secured to a frame 380 that is mechanically decoupled from the housing 329 of the module 300. The frame 380 has legs 381 that are secured to a heat dissipation device 390 of the module 300. Due to space constraints inside of the module 300, the frame 380 may be in contact with portions of the housing 329, but not in a way that allows forces that are transferred into the housing 329 to be transferred from the housing 329 into the frame 380.

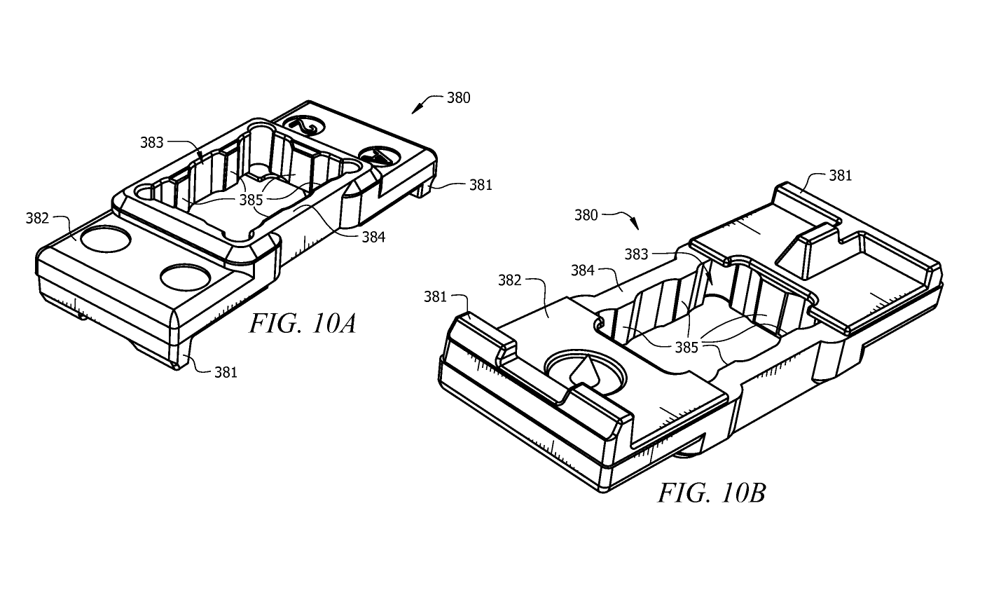

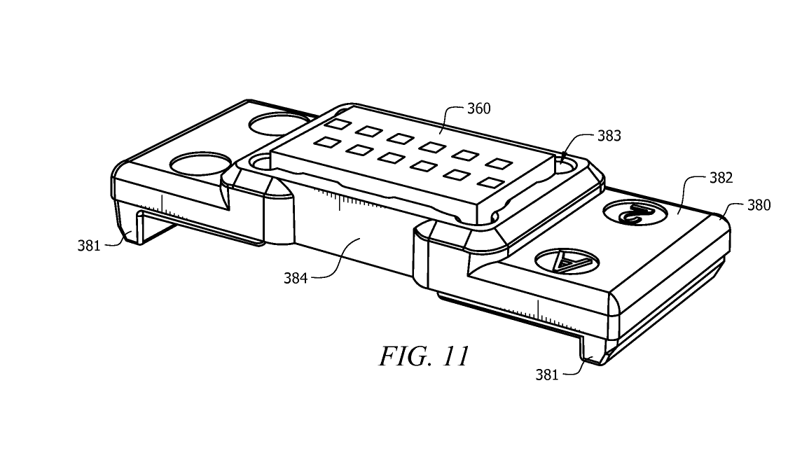

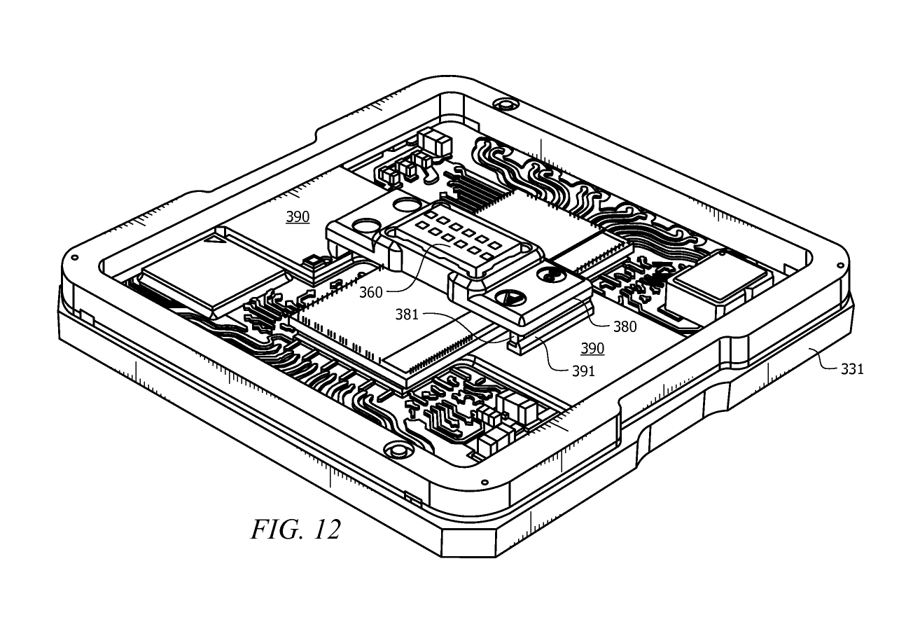

FIGS. 10A and 10B illustrate top and bottom perspective views, respectively, of the frame 380 shown in FIGS. 9A and 9B. FIG. 11 illustrates a top perspective view of the frame 380 having the optics system 360 secured thereto. FIG. 12 illustrates a top perspective view of the optical communications module 300 shown in FIGS. 8-9B with the housing 329 removed to reveal the components of the module that are housed within the housing 329. The frame 380 is typically a molded plastic part comprising a support structure 382 having a central portion 384 (FIGS. 9A and 9B) in which an opening 383 is formed. The central portion 384 of the support structure 382 has bumps, or ridges, 385 (FIGS. 10A and 10B) formed on its interior surface that abut the sides of the optics system 360 when the optics system 360 is disposed within the opening 383 (FIG. 11). The optics system 360 is typically either press fit into the opening 383 or is secured to within the opening 383 by an adhesive material such as epoxy or the like. Other types of securing mechanisms or materials may be used to secure the optics system 360 to the frame 380.

With reference to FIGS. 9B and 12, the legs 381 of the frame 380 are secured to the surface of the heat dissipation device 390 by an adhesive material 391 (FIG. 12), such as epoxy. Lower surfaces of first and second heat dissipation blocks 392 and 393 (FIG. 9B), which are typically copper blocks, are secured by a thermally-conductive epoxy (not shown) to the heat dissipation device 390. As shown in FIG. 8, upper surfaces of the heat dissipation blocks 392 and 393 are exposed through the openings formed in the housing 329 so that the blocks 392 and 393 can be mechanically and thermally coupled with an external heat dissipation structure (not shown), which is typically provided by the customer to whom the module 300 is shipped. The housing 329 acts as a cover such that when it is secured to a PCB 331 of the module 300, the components of the module 300 shown in FIG. 12 are encased in a compartment defined by the inner surfaces of the housing 329 and the upper surface of the PCB 331. The compartment preferably is not a hermetically-sealed compartment, but is sufficiently sealed to substantially impede the flow of air, other gasses and contaminants into the interior of the module 300. The same is true for the module 120 shown in FIG. 3.

With reference again to FIG. 9B, by mechanically decoupling the optics system 360 from the housing 329, any forces that are exerted on the mating surface 322 of the housing 329 will not be transferred into the optics system 360. Consequently, this decoupling feature prevents the optics system 360 from being damaged or moved out of alignment by external forces that are exerted on the mating surface 322.

The strike plate 330 protects the optics system 360 in the same manner in which the strike plate 130 (FIGS. 3 and 4) protects the optics system of the optical communications module 120 (FIG. 3). In particular, if the pins 144 and/or 145 of the connector module 140 (FIG. 5) come into contact with the strike plate 330 (FIGS. 9A and 9B) during the process of mating the connector module 140 with the optical communications module 300 (FIG. 8), the corresponding force that is exerted on the strike plate 330 will be evenly distributed by the strike plate 330 into the housing 329 (FIG. 8) of the module 300. In this way, the strike plate 330 prevents forces that are exerted on the mating surface 322 of the optical communications module 300 from being concentrated around the optics system 360 and causing damage to the optics system 360 or moving it out of alignment.

The optically-transmissive window 350 (FIGS. 8-9B) is typically made of the same molded plastic material that is used to make the housing 329, which is typically, but not necessarily, ULTEM polyetherimide made by Saudi Basic Industries Corporation (SABIC) of Saudi Arabia. The window 350 comprises an optically-transmissive element 351 (FIG. 9B) that is transmissive to the operating wavelength of the module 300, i.e., the wavelength(s) of light that is transmitted and/or received by the module 300. As shown in FIG. 9B, the optically-transmissive element 351 has upper and lower surfaces 351a and 351b, respectively. The upper and lower surfaces 351a and 351b are coated with AR coatings, which are generally transparent and therefore are not visible in the figures. These AR coatings minimize reflections of light of the operating wavelength that is incident on the upper and lower AR-coated surfaces 351a and 351b. Therefore, light of the operating wavelength that is directed in the direction of arrow 401 (FIG. 9B) normal to the surface 351a will not be reflected to a significant extent at the surface 351a and will pass through the optically-transmissive element 351 Likewise, light of the operating wavelength that is directed in the direction of arrow 402 (FIG. 9B) normal to the surface 351b will not be reflected to any significant extent at the surface 351b and will pass through the optically-transmissive element 351. In this way, the optically-transmissive window 350 is transmissive to light of the operating wavelength, and allows the optics system 360 to be located beneath the mating surface 322 so that forces that are exerted on the mating surface 322 are not transferred to the optics system 360.

In addition, the optically-transmissive element 351 is embedded in, or integrally formed in, the mating surface 322 such that the upper surface 351a is in close proximity to the mating surface 322 and is almost coplanar with the mating surface 322, as shown in FIG. 9B. Embedding or forming the optically-transmissive element 351 in the mating surface 322 provides the same sealing benefits as those described above with reference to the optics system 11 embedded in the mating surface 12 of the known optical communications module 3 shown in FIGS. 1A-1D. The housing 329 (FIG. 8), which is typically made of plastic, isolates the optics system 360 and the components that are mounted on the PCB 331 (FIG. 12) from dust, water vapor and mixed flow gases. The optically-transmissive element 351 maintains this sealed arrangement by preventing dust, water vapor and mixed flow gases from entering the interior of the housing 329 through the optically-transmissive window 350.

As indicated above, one or more of the protection features described above are incorporated into the optical communications module to protect the optics system from being damaged or moved out of its aligned position. The strike plate redistributes the mechanical load associated with forces that are applied to the strike plate, such as forces associated with the pins of the connector module coming into contact with the strike plate during the process of mating the connector module with the optical communications module. The optically-transmissive window allows the optics system to be positioned beneath the mating surface so that any forces that are exerted on the mating surface are not transferred to the optics system. The decoupling feature mechanically decouples the optics system from the mating surface of the optical communications module to prevent forces that are exerted on the mating surface from being transferred to the optics system. These protection features, therefore, used along or in combination, prevent the optics system from being damaged or moved out of alignment by forces that are exerted on the mating surface.

It should be noted that the invention has been described with respect to illustrative embodiments for the purpose of describing the principles and concepts of the invention. The invention is not limited to these embodiments. For example, although the illustrative embodiments of the invention have been described in connection with optical communications modules having particular designs, the inventions are not limited with respect to the optical communication module designs with which they can be used. Also, although the protection features have been described with reference to particular illustrative embodiments, many variations may be made to the embodiments of the protection features within the scope of the invention. As will be understood by those skilled in the art in view of the description being provided herein, such variations are within the scope of the invention.

What is claimed is:

1. An optical communications module comprising:
a circuit board having at least an upper surface and a lower surface;
one or more electronic components and one or more optoelectronic components mounted on the upper surface of the circuit board;
a module housing mechanically coupled to the circuit board, the module housing having an upper surface corresponding to a mating surface of the module for mating with a connector module;
an optics system disposed in the module housing; and
a strike plate disposed on at least a portion of the mating surface, wherein the strike plate has at least a first opening extending through the strike plate for allowing light to be optically coupled between a connector module and the optics system when the optical communications module is engaged in a mating arrangement with a connector module, and wherein the strike plate is adapted to redistribute a force exerted on the strike plate by the connector module such that the redistributed force is generally equally distributed over the portion of the mating surface on which the strike plate is disposed.

2. The optical communications module of claim 1, wherein the module housing has at least first and second mating holes formed therein for receiving first and second mating pins, respectively, disposed on a lower surface of the connector module to engage the connector module in the mating engagement with the optical communications module, and wherein the first and second holes pass through the mating surface of the module housing, and wherein said at least a first opening formed through the strike plate exposes the first and second holes to allow the first and second mating pins of the connector module to be received in the first and second holes, respectively.

3. The optical communications module of claim 2, wherein strike plate is substantially planar in shape and has an upper surface and a lower surface that are parallel to one another and parallel to the mating surface of the module housing.

4. The optical communications module of claim 3, wherein strike plate is made of a metallic material.

5. The optical communications module of claim 4, wherein the metallic material is sheet metal.

6. The optical communications module of claim 4, wherein the metallic material is aluminum.

7. The optical communications module of claim 1, further comprising:
an optically-transmissive window disposed in the mating surface, the optically-transmissive window comprising an optically-transmissive element having upper and lower surfaces that are parallel to one another and parallel to the mating surface, the upper and lower surfaces of the optically-transmissive element having first and second anti-reflection (AR) coatings, respectively, disposed thereon, and wherein the optics system is disposed beneath the optically-transmissive element.

8. The optical communications module of claim 7, wherein the optically-transmissive element is embedded in or integrally formed in the mating surface.

9. The optical communications module of claim 7, further comprising:
a frame disposed in the module housing beneath the optically-transmissive element and above the upper surface of the circuit board, wherein the frame is mechanically decoupled from the mating surface, and wherein the optics system is mounted on the frame and is mechanically decoupled from the mating surface, and wherein mechanically decoupling the frame and the optics system from the mating surface helps prevent external forces that are exerted on the mating surface of the module housing from being transferred to the optics system.

10. An optical communications module comprising:
a circuit board having at least an upper surface and a lower surface;
one or more electronic components and one or more optoelectronic components mounted on the upper surface of the circuit board;
a module housing mechanically coupled to the circuit board, the module housing having an upper surface corresponding to a mating surface of the module for mating with a connector module, the mating surface having an optically-transmissive window formed therein;
a frame disposed in the module housing beneath the optically-transmissive window and above the upper surface of the circuit board, wherein the frame is mechanically decoupled from the mating surface; and
an optics system mounted on the frame beneath the optically-transmissive window, and wherein if external forces are exerted on the mating surface of the module housing, the mechanical decoupling of the frame from the mating surface helps prevent such external forces from being transferred to the optics system.

11. The optical communications module of claim 10, further comprising:
a strike plate disposed on at least a portion of the mating surface, wherein the strike plate has at least a first opening extending through the strike plate for allowing light to be optically coupled between a connector module and the optics system through the optically-transmissive window when the optical communications module is engaged in a mating arrangement with a connector module, and wherein the strike plate is adapted to redistribute a force exerted on the strike plate by the connector module such that the redistributed force is generally equally distributed over the portion of the mating surface on which the strike plate is disposed.

12. The optical communications module of claim 10, wherein the module housing has at least first and second mating holes formed therein for receiving first and second mating pins, respectively, disposed on a lower surface of the connector module to engage the connector module in the mating engagement with the optical communications module, and wherein the first and second holes pass through the mating surface of the module housing, and wherein said at least a first opening formed through the strike plate exposes the first and second holes to allow the first and second mating pins of the connector module to be received in the first and second holes, respectively.

13. The optical communications module of claim 11, wherein strike plate is substantially planar in shape and has an upper surface and a lower surface that are parallel to one another and parallel to the mating surface of the module housing.

14. The optical communications module of claim 10, wherein the optically-transmissive window comprises an optically-transmissive element having upper and lower surfaces that are parallel to one another and parallel to the mating surface, the upper and lower surfaces of the optically-transmissive element having first and second anti-reflection (AR) coatings, respectively, disposed thereon for passing light of an operating wavelength of the optical communications module.

15. The optical communications module of claim 14, wherein the optically-transmissive element is embedded in or integrally formed in the mating surface.

16. An optical communications module comprising:
a circuit board having at least an upper surface and a lower surface;
one or more electronic components and one or more optoelectronic components mounted on the upper surface of the circuit board;
a module housing mechanically coupled to the circuit board, the module housing having an upper surface corresponding to a mating surface of the module for mating with a connector module, the mating surface having an optically-transmissive window formed therein;
an optically-transmissive element disposed in the optically-transmissive window, the optically-transmissive element having upper and lower surfaces that are parallel to one another and parallel to the mating surface, the upper and lower surfaces of the optically-transmissive element having first and second anti-reflection (AR) coatings, respectively, disposed thereon for passing light of an operating wavelength of the optical communications module; and
an optics system disposed in the module housing beneath the optically-transmissive element and above the upper surface of the circuit board.

17. The optical communications module of claim 16, wherein the optically-transmissive element is embedded in or integrally formed in the mating surface.

18. The optical communications module of claim 16, further comprising:
a frame disposed in the module housing beneath the optically-transmissive window and above the upper surface of the circuit board, wherein the frame is mechanically decoupled from the mating surface, and wherein the optics system is mounted on the frame beneath the optically-transmissive window, and wherein if external forces are exerted on the mating surface of the module housing, the mechanical decoupling of the frame from the mating surface helps prevent such external forces from being transferred to the optics system.

19. The optical communications module of claim 16, further comprising:
a strike plate disposed on at least a portion of the mating surface, wherein the strike plate has at least a first opening extending through the strike plate for allowing light to be optically coupled between a connector module and the optics system through the optically-transmissive window when the optical communications module is engaged in a mating arrangement with a connector module, and wherein the strike plate is adapted to redistribute a force exerted on the strike plate by the connector module generally equally over the portion of the mating surface on which the strike plate is disposed.

20. The optical communications module of claim 19, wherein the module housing has at least first and second mating holes formed therein for receiving first and second mating pins, respectively, disposed on a lower surface of the connector module to engage the connector module in the mating engagement with the optical communications module, and wherein the first and second holes pass through the mating surface of the module housing, and wherein said at least a first opening formed through the strike plate exposes the first and second holes to allow the first and second mating pins of the connector module to be received in the first and second holes, respectively.

21. The optical communications module of claim 19, wherein the strike plate is substantially planar in shape and has an upper surface and a lower surface that are parallel to one another and parallel to the mating surface of the module housing.

22. A method for protecting an optics system of an optical communications module from being damaged by external forces that are applied to a mating surface of the module, the method comprising:
disposing a strike plate on at least a portion of a mating surface of a housing of an optical communications module, wherein the strike plate has at least a first opening extending through the strike plate for allowing light to be optically coupled between a connector module and the optical communications module when the optical communications module is matingly engaged with the connector module, and wherein the strike plate is adapted to redistribute a force exerted on the strike plate by the connector module such that the redistributed force is generally equally distributed over the portion of the mating surface on which the strike plate is disposed.

23. The method of claim 22, wherein the mating surface has an optically-transmissive window disposed therein, the optically-transmissive window comprising an optically-transmissive element having upper and lower surfaces that are parallel to one another and parallel to the mating surface, the upper and lower surfaces of the optically-transmissive element having first and second anti-reflection (AR) coatings, respectively, disposed thereon, and wherein an optics system of the optical communications module is disposed in the housing beneath the optically-transmissive element.

24. The method of claim 23, wherein the optically-transmissive element is embedded in or integrally formed in the mating surface.

25. The method of claim 22, wherein the optics system is disposed on a frame located inside of the housing beneath the optically-transmissive element, wherein the frame is mechanically decoupled from the mating surface, and wherein the optics system is mounted on the frame and is decoupled from the mating surface, and wherein the mechanical decoupling of the frame and the optics system from the mating surface helps prevent external forces that are exerted on the mating surface of the module housing from being transferred to the optics system.

26. A method for protecting an optics system of an optical communications module from being damaged by external forces that are applied to a mating surface of the module, the method comprising:
disposing an optics system on a frame of the optical communications module; and
the frame being disposed in a housing of the optical communications module beneath an optically-transmissive window formed in a mating surface of the housing, wherein the frame is mechanically decoupled from the mating surface, and wherein if external forces are exerted on the mating surface of the housing, the mechanical decoupling of the frame from the mating surface helps prevent such external forces from being transferred to the optics system.

27. The method of claim 26, further comprising:
disposing a strike plate on at least a portion of the mating surface of the housing, wherein the strike plate has at least a first opening extending through the strike plate for allowing light to be optically coupled between a connector module and the optical communications module when the optical communications module is matingly engaged with the connector module, and wherein the strike plate is adapted to redistribute a force exerted on the strike plate by the connector module such that the redistributed force is generally equally distributed over the portion of the mating surface on which the strike plate is disposed.

28. The method of claim 26, wherein the optically-transmissive window comprises an optically-transmissive element having upper and lower surfaces that are parallel to one another and parallel to the mating surface, the upper and lower surfaces of the optically-transmissive element having first and second anti-reflection (AR) coatings, respectively, disposed thereon for passing light of an operating wavelength of the optical communications module.

29. A method for protecting an optics system of an optical communications module from being damaged by external forces that are applied to a mating surface of the module, the method comprising:
providing a mating surface of a housing of an optical communications module with an optically-transmissive window having an optically-transmissive element disposed therein, the optically-transmissive element having upper and lower surfaces that are parallel to one another and parallel to the mating surface, the upper and lower surfaces of the optically-transmissive element having first and second anti-reflection (AR) coatings, respectively, disposed thereon for passing light of an operating wavelength of the optical communications module; and
disposing an optics system in the housing beneath the optically-transmissive element and above at least one optoelectronic component mounted an upper surface of a circuit board of the module, wherein the optics system is mechanically decoupled from the mating surface.

30. The method of claim 29, wherein the optics system is disposed on a frame of the optical communications module, wherein the frame is mechanically decoupled from the mating surface.

31. The method of claim 29, further comprising:
disposing a strike plate on at least a portion of the mating surface of the housing, wherein the strike plate has at least a first opening extending through the strike plate for allowing light to be optically coupled between a connector module and the optical communications module when the optical communications module is matingly engaged with the connector module, and wherein the strike plate is adapted to redistribute a force exerted on the strike plate by the connector module such that the redistributed force is generally equally distributed over the portion of the mating surface on which the strike plate is disposed.
